(19) United States
(12) Patent Application Publication
(10) Pub. No.: US 2008/0174565 A1
(43) Pub. Date: Jul. 24, 2008

(54) Touch pad device

(75) Inventors: Ching-Sung Chang, Taipei (TW); David Ho, Taipei (TW); Po-Cheng Chen, Taipei (TW); Sea-Weng Young, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/808,866

(22) Filed: Jun. 13, 2007

(30) Foreign Application Priority Data
Jan. 19, 2007 (TW) 96102202

(51) Int. Cl. G06F 3/041

(52) U.S. Cl. 345/173

(57) ABSTRACT

A touch pad device, constructed in an electronic apparatus, includes a touch module further having a touch pad and an FPCB and a plurality of metal domes located under the FPCB. The FPCB located under the touch pad further has a plurality of holes and a plurality of sensor elements, in which the holes are dispersed amid the sensor elements. Each of the metal domes represents a function key. By providing the plural holes surrounding the sensor elements, flexibility of the touch pad device can be enhanced and over deflection upon the touch module can be avoided, while pressing the function key.

This application claims the benefit of Taiwan Patent Application Serial No. 96102202, filed Jan. 19, 2007, the subject matter of which is incorporated herein by reference.

### BACKGROUND OF THE INVENTION

(1) Field of the Invention

The invention relates to a touch pad device, and more particularly to the device that provides plural metal domes and that can alter the forcing pattern by introducing structural change.

(2) Description of the Prior Art

Applications of directional push button devices or touch pad devices are widely used in computers, personal digital assistants, and index input devices of electronic apparatuses. In the art, formulations of the push button devices are various and already well known to the related skilled persons. As shown in FIG. 1 demonstrates one of those variety.

As illustrated, the push button device mainly includes a button unit 10, a film 12 made of thermoplastic Polyurethane pellets (TPU), a flexible printed circuit board (FPCB) 14, a metal grid 16, and a rubber keypad interface 18. The button unit 10 including plural pop-up buttons is exposed to the housing of carrier apparatus. The TPU film 12 is introduced to prevent the button unit 10 from directly contacting the FPCB 14. The FPCB 14 provides a transducer 140 for forwarding electrically a touch signal upon the button unit 10 to a processing unit of the carrier apparatus. The metal grid 16 and the rubber keypad interface 18 are there to ensure the assembly of the push button device. In addition, the rubber keypad interface 18 can prevent the FPCB 14 from over deflection while in meeting extraordinary force upon the button unit 10.

No matter whether the touch pad is of a resistant type, an electromagnetic type, or an inductance type, it mainly provides the film and the FPCB to receive a control touch signal that can be realized further as indication of a 2D (2-dimension) moving control of the user.

Generally speaking, the touch pad is substantially a planar structure. In finger-inputting operation through the planar touch pad, less reaction sensibility against the action finger usually causes caution-less problems, such as multiple clicks, overtime pressing, or too-short-to-be-sensed touches. Definitely, either of the aforesaid problems results in operation errors or inconvenient usage.

Therefore, a push button type of the touch pad that could provide precise touch response without sacrificing comforts for user is definitely popular among the skilled person in the art.

### SUMMARY OF THE INVENTION

Accordingly, it is an object of the present invention to provide a touch pad device that introduces structural changes to alter force pattern thereupon and thereby to enhance the applicability of the touch pad device.

In the present invention, the touch pad device, constructed in an electronic apparatus, includes a touch module and a plurality of metal domes. The touch module further comprises a touch pad and a flexible printed circuit board (FPCB). The touch pad performs as a touch interface of the apparatus for a user. The FPCB located under the touch pad further comprises a plurality of holes and a plurality of sensor elements, in which the holes are isolated from and dispersed amid the sensor elements. The FPCB can receive a user touch and produce corresponding cursor signals and controls to move a cursor shown on a display of the electronic apparatus. The plural metal domes are located under the FPCB, each of which is in a position to account for a specific function key. By providing the plural holes to surround the sensor elements, flexibility of the touch pad device can be enhanced and possible over-deflection upon the touch module can be successfully avoided.

All these objects are achieved by the touch pad device described below.

### BRIEF DESCRIPTION OF THE DRAWINGS

The present invention will now be specified with reference to its preferred embodiment illustrated in the drawings, in which:

FIG. 1 is an exploded view of a conventional touch pad device;

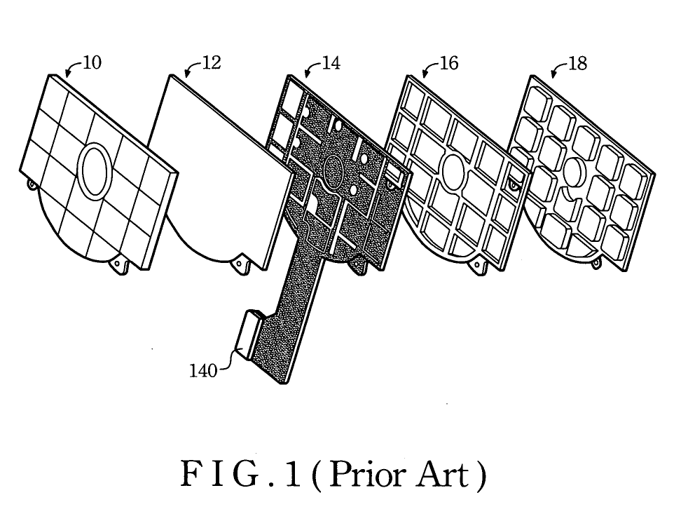

FIG. 2A is a front view and a top view of a preferred touch pad device in accordance with the present invention;

FIG. 2B is a front view and a top view of the FPCB of FIG. 2A;

FIG. 3A is a front view and a top view of another touch pad device in accordance with the present invention;

FIG. 3B is a front view and a top view of the FPCB of FIG. 3A;

FIG. 4 shows an appearance of the touch pad device in accordance with the present invention; and

FIG. 5 illustrates an example that a user touch on the touch pad device in accordance with the present invention.

### DESCRIPTION OF THE PREFERRED EMBODIMENT

The invention disclosed herein is directed to a touch pad device. In the following description, numerous details are set forth in order to provide a thorough understanding of the present invention. It will be appreciated by one skilled in the art that variations of these specific details are possible while still achieving the results of the present invention. In addition, well-known components are not described in detail in order not to unnecessarily obscure the present invention.

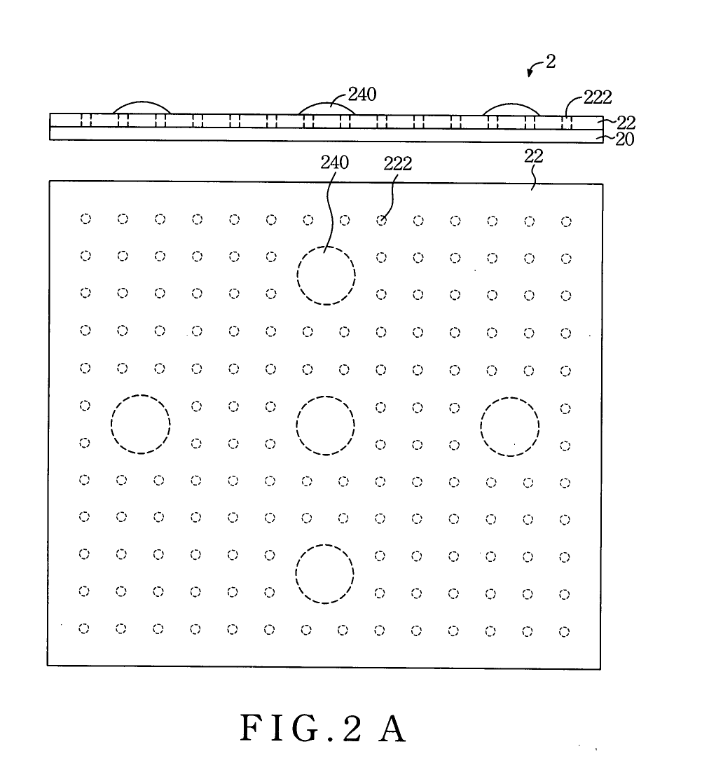

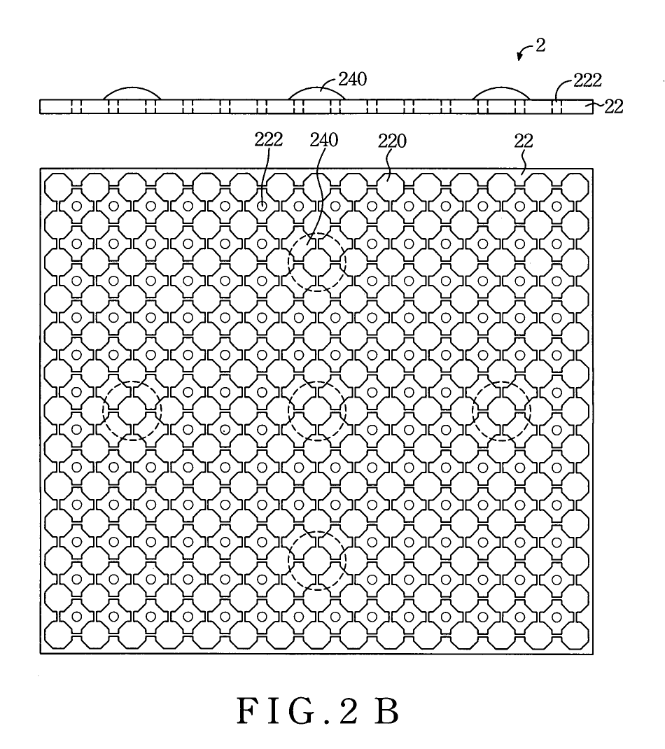

Referring now to both FIG. 2A and FIG. 2B, a preferred touch pad device of the present invention and a flexible printed circuit board (FPCB) 22 of the touch pad device are shown, respectively.

The touch pad device is mounted inside an electronic apparatus that can be a mobile phone, a personal digital assistant, an MP3 player, an input device of a notebook computer, or any the like. As shown, the touch pad device includes a touch module 2 and a plurality of metal domes 240. In the present invention, the touch module 2 can be a capacitor type, an electromagnetic type, or a resistance type. Details to distinguish these three types are well known to the skilled person in the art and thus omitted herein.

The touch module 2 includes a touch pad 20 and a FPCB 22. The touch pad 20 as an interface between the touch pad device 2 and a user can be made of a thermoplastic material (for example, a thermoplastic polyurethane pellet), a transparent material, or a semi-transparent material. The FPCB 22 located under the touch pad 20 can include a plurality of holes 222 and a plurality of sensor elements 220. Preferably, the plural holes 222 are isolated from and dispersed among the sensor elements 220; i.e., arranged in a matrix pattern as shown particular in FIG. 2B. Practically, each of the holes 222 is a hole drilled in the space between the sensor elements 220. In the present invention, the diameter of the hole 222 depends on the room available in the space between the sensor elements 220, and is preferably ranged between 0.6 mm and 2.0 mm.

The plural metal domes 240 are located under the FPCB 22, each of which is in a position corresponding to a specific sensor element 220. Each of the metal domes 240 basically represents a specific function key. In the present invention, according to a proper circuits layout, the metal domes 240 can be located directly, or in a predetermined spacing, to the FPCB 22. In the present invention, sizes and number of the metal domes 240 depend on practical design requirements.

In the case that a user presses upon a specific metal dome 240 (i.e. a corresponding function key), contributed by the plural holes 222, the deflection of the FPCB 22 can be limited and localized; i.e., limited to a small area centered at the pressed metal dome 240. That is to say, by way of introducing the holes 222 to surround each of the sensor elements 220, the flexibility of the FPCB 22 as well as the touch pad 20 can be increased. Upon such an arrangement, pressing on a specific sensor element 220 can only deflect a limited portion around the current sensor element 220, and the influence of accidentally pressing the other sensor elements 220 can be reduced to a minimum, even be eliminated.

In the case that a user touches the touch pad 20 by his/her finger or a writing stylus, the FPCB 22 would generate a voltage signal in response to the user touch, and further to produce corresponding cursor signals and controls to move a cursor shown on a display of the electronic apparatus.

The FPCB 22 can determine, by judging the action duration, for example, if the user touch is to perform a click function or a button-press function. In the case that the action duration is over 25 ms, the force is over a predetermined magnitude, or the force is not detected by any of the other sensor elements 220 in 25 ms, the user touch is deemed as a button-press application on the incident metal dome 240, or call the function key. Then, the function corresponding the incident metal dome 240 is performed and the touch pad 20 is temporarily disabled. On the other hand, for example, in the case that the action duration is not over 25 ms, the force is not over a predetermined magnitude, or the force is detected by any of the other sensor elements 220 in 25 ms, the user touch is deemed as a click application on the incident metal dome 240. In practice, in the case that a button-press application and a click application are simultaneously detected, one of the button-press application and the click application could be deemed first priority. For example, the button-press application is preferred the first to be performed.

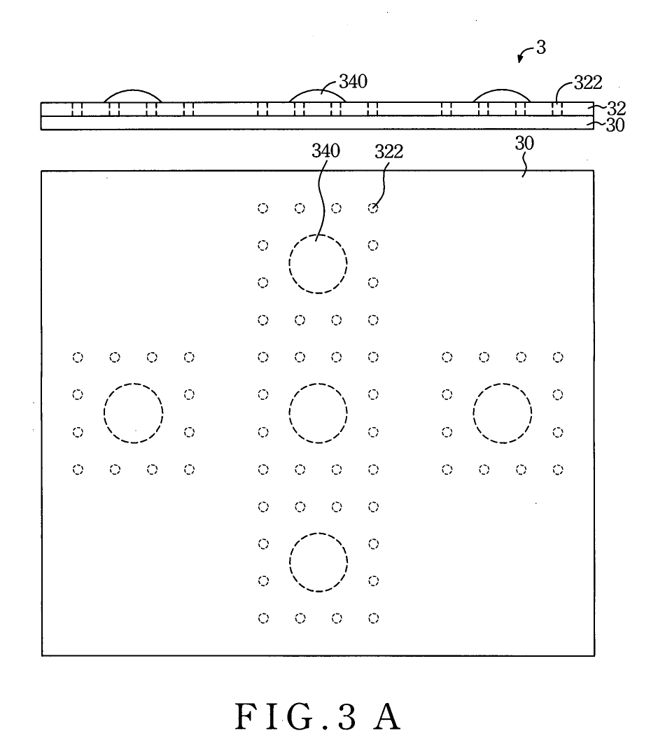

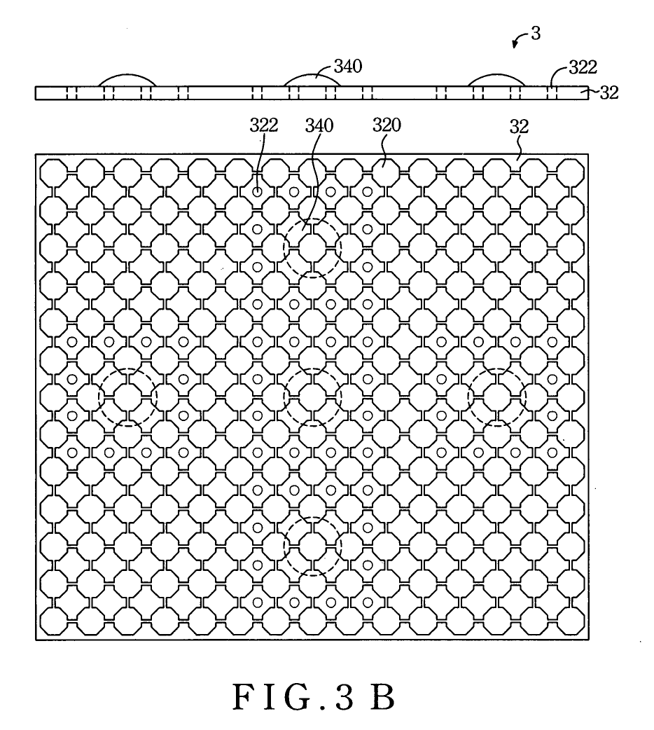

Referring now to both FIG. 3A and FIG. 3B, another embodiment of the touch pad device in accordance with the present invention and a flexible printed circuit board (FPCB) 32 of the touch pad device are shown, respectively.

In comparison to the embodiment shown in FIG. 2A and FIG. 2B, in particular to the FPCB 22, in which the holes 222 are evenly distributed all over the FPCB 22 and dispersed among sensor elements 220 in a matrix form, the holes 322 of the FPCB 32 in this embodiment are distributed only to some limited areas that are centered individually by the metal domes 340. Upon such an arrangement, enhanced flexibility is only provided in the area of the FPCB 32 surrounding each metal dome 340, and thus over deflection of the FPCB 32 and the touch pad 30 can be avoided. Also, possibility of mis-reading the user touch can be reduced to a minimum.

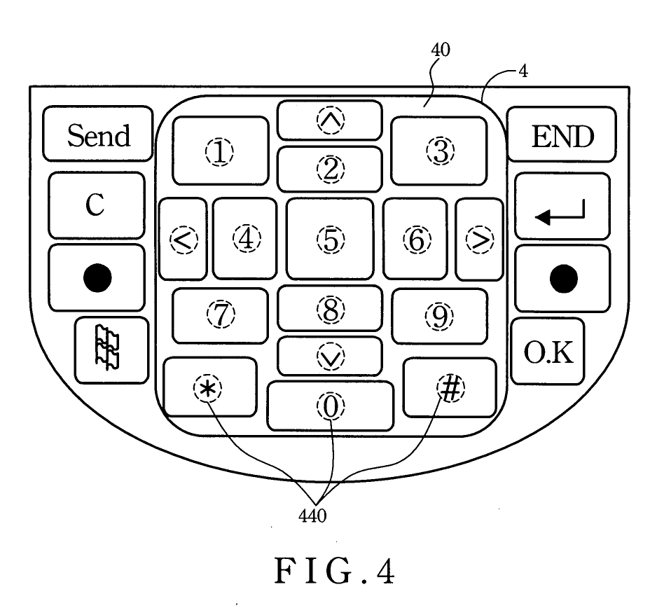

Referred now to FIG. 4, an appearance of the touch pad device in accordance with the present invention is shown. As illustrated, the input device of the electronic apparatus includes plural function keys and the touch pad device of the present invention. The touch pad 40 of the touch pad device includes a plurality of printed symbols. Under each symbol locates one respective metal dome (represented by dashed circles) 440. The planar touch pad 40 is easy to be touched by the user and can also provide lots of function keys such as keys of #, *, >, <, [symbol] and [symbol] .

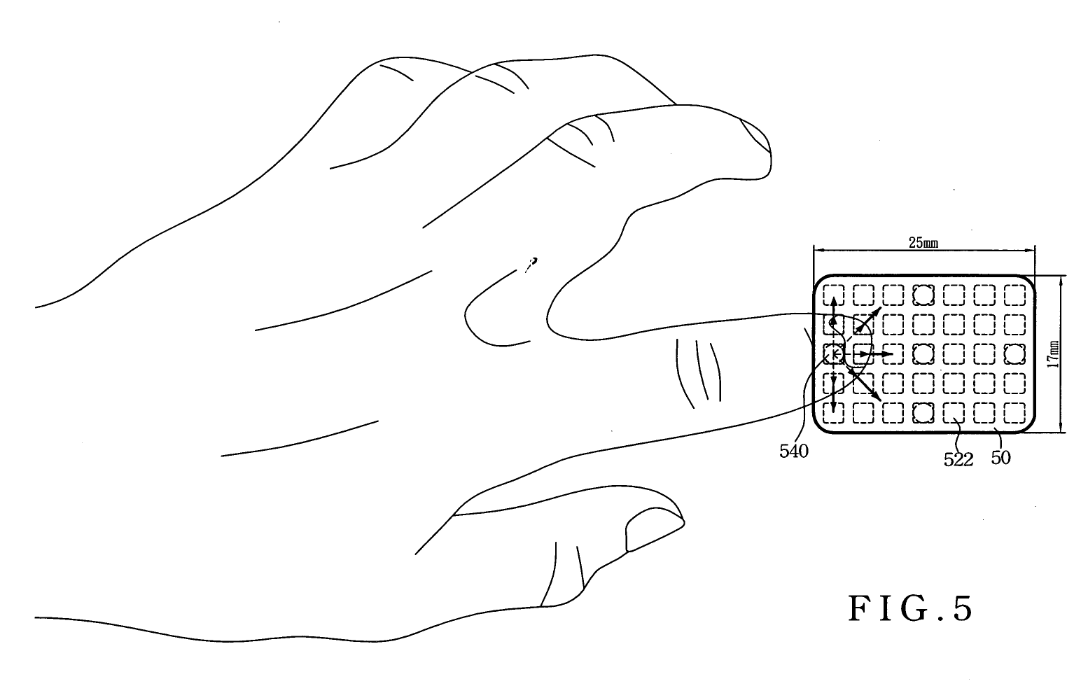

Referring now to FIG. 5, a user touch and operate on the touch pad device of the present invention is illustrated. As shown, the touch pad 50 of the touch pad device is a 17 mm×25 mm pad, and the touch pad device has a 5×7 matrix of the sensor elements 522 and 5 metal domes 540. The metal dome 540 at the left hand side of the touch pad 50 is the one that accepts the user touch. Contributed by the holes surrounding the metal dome 540, the deflection of the touch pad 50 as well as that of the FPCB (not shown in the figure) located under the touch pad 50 can be limited to a pretty small effective area covered by the arrows as shown. As noted, the effective area corresponding such a user touch can only cover a single metal dome 540, and the rest metal domes 540 won't be substantially affected.

By providing the present invention, a plurality of the holes on the FPCB are located at areas that bear the metal domes, such that the flexibility around the metal dome can be locally enhanced and can prevent both the FPCB and the touch pad from a wide-area deflection while being pressed. Also, upon such an arrangement, more function keys (equally, metal domes) can be mounted to the touch pad device without increasing possibility of mis-reading the user touch.

While the present invention has been particularly shown and described with reference to a preferred embodiment, it will be understood by those skilled in the art that various changes in form and detail may be without departing from the spirit and scope of the present invention.

I claim:

1. A touch pad device for an electronic apparatus, comprising:
a touch module, further including a touch pad and a flexible printed circuit board (FPCB) located under the touch pad, the touch pad providing an input interface for a user, the FPCB generating a cursor signal in response to a touch thereupon of the user, the FPCB having a plurality of through portions and a plurality of sensor elements, each of the through portions being located between adjacent two of the sensor elements; and
a plurality of metal domes, located under the FPCB, each of the metal domes representing a position of a respective function key.

2. The touch pad device according to claim 1, wherein said electronic apparatus is a mobile phone, a personal digital assistant, an MP3 player or an input device of a notebook computer.

3. The touch pad device according to claim 1, wherein said through portions has a diameter ranged between 0.6 mm and 2.0 mm.

4. The touch pad device according to claim 1, wherein said metal dome is located under one said respective sensor element surrounded by a number of said through portions.

5. The touch pad device according to claim 1, wherein said through portions are distributed around said metal domes.

6. The touch pad device according to claim 1, wherein said through portions are arranged in a predetermined matrix pattern.

7. A touch pad device, mounted inside an electronic apparatus, comprising a touch module and a plurality of metal domes, the touch module further including a touch pad and a flexible printed circuit board (FPCB) further having a plurality of through portions and a plurality of sensor elements, each of the metal domes representing respective function keys located under the FPCB at a position corresponding to where one said sensor element is located, characterized on that: each of the through portions is located between adjacent two of the sensor elements, and the touch pad device provides a reaction force against a touch by a user upon the corresponding function key.

8. The touch pad device according to claim 7, wherein said through portions are distributed around said metal domes.

9. The touch pad device according to claim 7, wherein said through portions are arranged in a predetermined matrix pattern.

10. The touch pad device according to claim 7, wherein said through portions has a diameter ranged between 0.6 mm and 2.0 mm.

11. The touch pad device according to claim 7, wherein said electronic apparatus is a mobile phone, a personal digital assistant, an MP3 player or an input device of a notebook computer.
